(19) United States
(12) Patent Application Publication
(10) Pub. No.: US 2013/0287343 A1
(43) Pub. Date: Oct. 31, 2013

(54) CABLE ADAPTER FOR A CAMERA CONVERTER

(71) Applicant: TACTICAL FIBER SYSTEMS, INC., Boca Raton, FL (US)

(72) Inventor: Richard David Rubin, Boca Raton, FL (US)

(21) Appl. No.: 13/869,773

(22) Filed: Apr. 24, 2013

Related U.S. Application Data
(60) Provisional application No. 61/637,913, filed on Apr. 25, 2012.

(51) Int. Cl. G02B 6/42; G02B 6/44

(52) U.S. Cl. CPC G02B 6/4257; G02B 6/4415
USPC 385/77

(57) ABSTRACT

A cable adapter or connector for an ATEM camera converter includes a bracket secured to at least two holes on a bottom of the ATEM camera converter. Also included is at least a Neutrik opticalCON® fiber chassis connector secured to a cut-out in the bracket by at least two rivets. Two dual ST chassis connectors or dual FC chassis connectors are installed in the cut-out of the bracket using one or more wide nuts with one or more lock-washers. There is also one or more fiber optic cables that terminate with at least one of the Neutrik opticalCON® or dual ST or dual FC chassis connectors. The fiber optic cables terminated with either Neutrik opticalCON®, dual ST or dual FC connectors may be used with the camera converter.

### RELATED APPLICATION

This application claims the benefit of U.S. Provisional Patent Application No. 61/637,913 filed Apr. 25, 2012, which application is incorporated herein by reference for all purposes.

### FIELD OF THE INVENTION

The present disclosure relates to connectors and more specifically to adaptors for ATEM camera converters that can be used with more durable optical fiber connections and cables.

### BACKGROUND

In the last few decades, there have been advancements in video production and particularly in live video production. Video production is a process of capturing moving images and creating video or a combination of parts of these video in live production and post-production. A video production may be done using a single camera or multiple camera setups. In multiple camera setups, several cameras may be connected to a video switcher via cable connectors and optical fibers. In addition, ATEM camera converters have revolutionized live video production. The ATEM camera converters enable connection between cameras and switchers via optical fiber cables up to 28 miles away and receive bi-directional audio, video, talkback, and tally signals. The duplex LC connector on the ATEM camera converter is used to connect it to an optical fiber cable for transmission.

The duplex LC fiber optic duplex socket of the ATEM camera converter requires a fiber optic cable that terminates with fragile plastic duplex LC connector. Unfortunately, cables terminated with LC connectors are not suitable for repeated deployment in the field because they can be easily damaged and/or contaminated by dirt/dust. Therefore, there exists a need for an improved cable adapter for the ATEM camera converter to facilitate use with fiber optic cables terminated with more robust connectors for reliable operation.

### BRIEF SUMMARY

Embodiments of the present disclosure provide a cable adapter for an ATEM camera converter. The cable adapter may include a bracket secured to at least two holes on bottom of the ATEM camera converter. The cable adapter may also include a Neutrik opticalCON® fiber chassis connector secured to a cut-out in the bracket by at least two rivets. The cable adapter may further include at least dual ST or dual FC chassis connectors installed in the cut-out of the bracket using one or more wide nuts with one or more lock-washers. The cable adapter may also include one or more fiber optic cables which terminate with at least one of the Neutrik opticalCON® or dual ST or dual FC chassis connectors, wherein the fiber optic cables are used with the camera converter.

Another embodiment of the present disclosure provides a cable adapter/connector for a Blackmagic® ATEM camera converter. The cable adapter/connector may include a bracket secured in at least two holes on bottom of the Blackmagic® ATEM camera converter and a Neutrik opticalCON® chassis connector secured to a cut-out in the bracket by at least two rivets. The cable adapter/connector may also include at least two dual ST or dual FC chassis connectors installed in the cut-out of the bracket using one or more wide nuts with one or more lock-washers. The cable adapter/connector may also include one or more fiber optic cables which terminate with at least one of the Neutrik opticalCON® or dual ST or dual FC chassis connectors, wherein the fiber optic cables are used with the camera converter. The cable adapter/connector may also include a strap attachment for allowing a user to hold the cable adapter firmly. Further, the cable adapter/connector may include an auxiliary battery supply.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1A is a top view of an exemplary cable adapter for ATEM camera converter, in accordance with an embodiment of the present disclosure;

FIG. 1B is a bottom view of the exemplary cable adapter of FIG. 1A;

FIG. 1C is a front view of the exemplary cable adapter of FIG. 1A;

FIG. 2 illustrates a Blackmagic® Design ATEM camera converter attached to the cable adapter of FIGS. 1A-1C;

FIGS. 3A-3B illustrates snapshots of the exemplary cable adapter of FIGS. 1A-1C with additional attachments, in accordance with various embodiments of the present disclosure; and

FIG. 4 illustrates another snapshot of the exemplary cable adapter, in accordance with an embodiment of the present disclosure.

### DETAILED DESCRIPTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

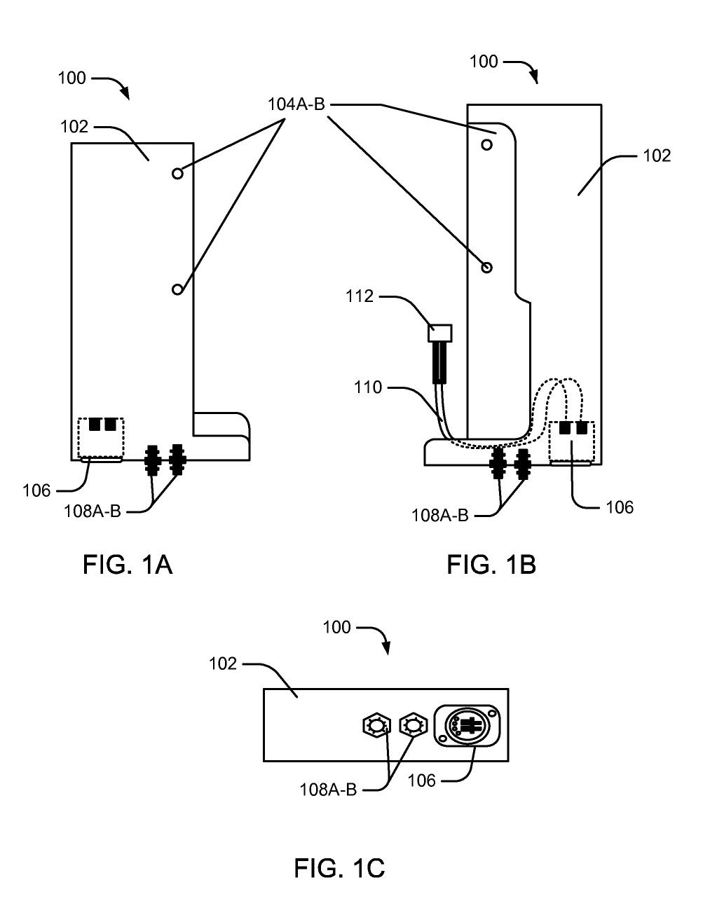

FIGS. 1A-1C are different views illustrating an exemplary cable adapter 100 (or a cable connector) that can be used in a camera converter. FIG. 1A is a top view of an exemplary cable adapter 100 for an ATEM camera converter, in accordance with an embodiment of the present disclosure. FIG. 1B is a bottom view of the exemplary cable adapter 100 of FIG. 1A. FIG. 1C is a front view of the exemplary cable adapter 100 of FIG. 1A.

As shown, the cable adapter 100 may include a bracket 102 secured to at least two holes 104A-104B on bottom of the ATEM camera converter (not shown). The holes 104A-104B are pre-existing holes on the ATEM camera converter and may be used to assemble the two halves of the camera converter. Further, shorter 3.0 mm screws in these holes 104A-104B may be removed to attach to the bracket 102 using longer 20 mm screws that may also hold the camera converter together. The bracket 102 may be formed by using any suitable material such as, but not limited to, high impact plastic or metal. The bracket 102 may be configured to protect an LC connection. The bracket 102 may further include a hermaphroditic connector of other more robust fiber optic connecter with a patch cable connecting the bracket 102 to a dual LC connector on the ATEM camera converter. The cable adapter 100 may be configured to connect to the ATEM camera converter by using at least two 3.0 mm by 20 mm screws. In an embodiment, the cable adapter 100 is a cable connector that can be used with the ATEM camera converter, such as, a Blackmagic® ATEM camera converter. Further, the bracket 102 may be made from a die-cut metal and using a machine formed according to specifications or injection molded plastic.

The cable adapter 100 may also include a Neutrik opticalCON® fiber chassis connector 106 secured to a cut-out in the bracket 102 by using at least two rivets. A person skilled in the art will appreciate that there can be any number of holes 104A-104B or rivets in the cable adapter 100 depending on the design of the ATEM camera converter. Further, there may be two types of Neutrik opticalCON® chassis connector 106 that may be used in the cable adapter 100 depending on a number of fiber cables 110 used with the cable adapter 100. The Neutrik opticalCON® connector 106 can be an opticalCON® “DUO” connector and/or an opticalCON® “QUAD” connector. The Neutrik opticalCON® DUO connector may be used to connect two fiber optic cables 110. Similarly, the Neutrik opticalCON® QUAD connector may be used to connect four fiber optic cables 110. In an embodiment, the fiber optic cable 110 terminated with the Neutrik opticalCON® DUO connector or two ST or dual FC connectors may connect fiber based signals that are used exclusively by the ATEM camera converter for its inherent functions. In another embodiment, when a Neutrik opticalCON® QUAD connector (or a combination of Neutrik opticalCON® QUAD connector/socket and cables) is used when additional two fiber optic cables may be patched to another fiber converter located adjacent to the ATEM camera converter to provide other functions. The other functions may include, but not limited to, sending data signals, receiving data signals for camera control or operating a tally light, and so forth.

The cable adapter 100 may also include at least two dual ST or dual FC chassis connectors 108A-108B installed in the cut out of the bracket 102 using one or more wide nuts along with one or more lock washers. The cable adapter 100 may further include one or more fiber optic cable(s) 110, which can terminate with either the Neutrik opticalCON® or dual ST or dual FC chassis connectors 106 or 108A-108B. The fiber optic cable(s) 110 may be used with the camera converter or modified camera converter. Herein after, an ATEM camera converter and a camera converter may be used interchangeably.

Further, the one or more fiber optic cable(s) 110 can be optical fiber patch cable for duplex LC to duplex LC connectors (such as 112). Alternatively, the fiber optic cable(s) 110 can be optical fibers patch cable for duplex LC connectors to dual ST or dual FC chassis connectors 108A-108B. For operation of the ATEM camera converter with fiber optic cable(s) 110 that are terminated with Neutrik opticalCON® chassis connector(s) 106, the patch cable may be connected between an inboard duplex LC socket of the Neutrik opticalCON® chassis connector 106 and the duplex LC socket on the ATEM camera converter. Alternatively, for operation of the ATEM camera converter with the fiber optic cable(s) 110 terminated with the dual ST or dual FC chassis connectors 108A-108B, the patch cable may be connected between an inboard one or more ST or dual FC sockets and the duplex LC socket on the ATEM camera converter. The cable adapter 100 allows the ATEM camera converter to be used with more durable fiber optic cables to ensure reliable fiber optic transmission without breakage or signal interruption.

The fiber optic cable(s) 110 that terminate with at least one of the Neutrik opticalCON® chassis connector 106 and the dual ST or dual FC chassis connectors 108A-108B may be plugged into a socket located on the ATEM camera converter. The cable adapter 100 may also include an auxiliary battery supply (See FIG. 4). The various patch cables may be custom cut and may be terminated with connectors 108A-108B and 106 using epoxy/polish methodology. The Neutrik opticalCON® chassis connector 106 may be fastened to the bracket 102 using a rivet gun (not shown).

In an embodiment, a hermaphroditic connector or other more robust fiber optic connector may be used in the cable adapter 100 in place of the Neutrik opticalCON® chassis connector 106 and may be installed in the bracket 102 with a patch cable connecting it to the dual LC connector on the ATEM camera converter.

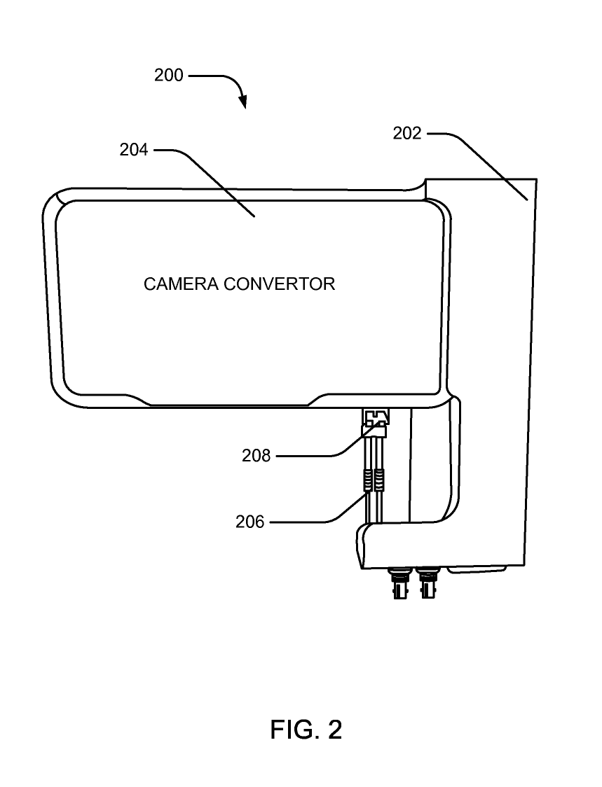

FIG. 2 illustrates an assembly 200 including a Blackmagic® Design ATEM camera converter 204 attached to a cable adapter 202 (or 100). The cable adapter 202 ensures integrity and reliability of fiber optic cable assemblies used to connect the signals from/to the ATEM camera converter 204 and the fiber optic receiver at the video production studio or control location. The cable adapter 202 includes a durable fiber optic socket 208 that allows the use of more durable fiber optic cable assemblies that can withstand the rigors of being dragged over the ground while being deployed from or rewound onto cable reels without breakage. The bracket (102) may protect the fragile LC connection. Further, the cable adapter 202 (or 100) may be configured for use with various optical fiber cable assemblies including Neutrik opticalCON® and Dual ST or dual FC chassis connectors. Further, the disclosed cable adapter 202 (or 100) may include one or more parts required to change the fiber optic cable used with the ATEM camera converter 204.

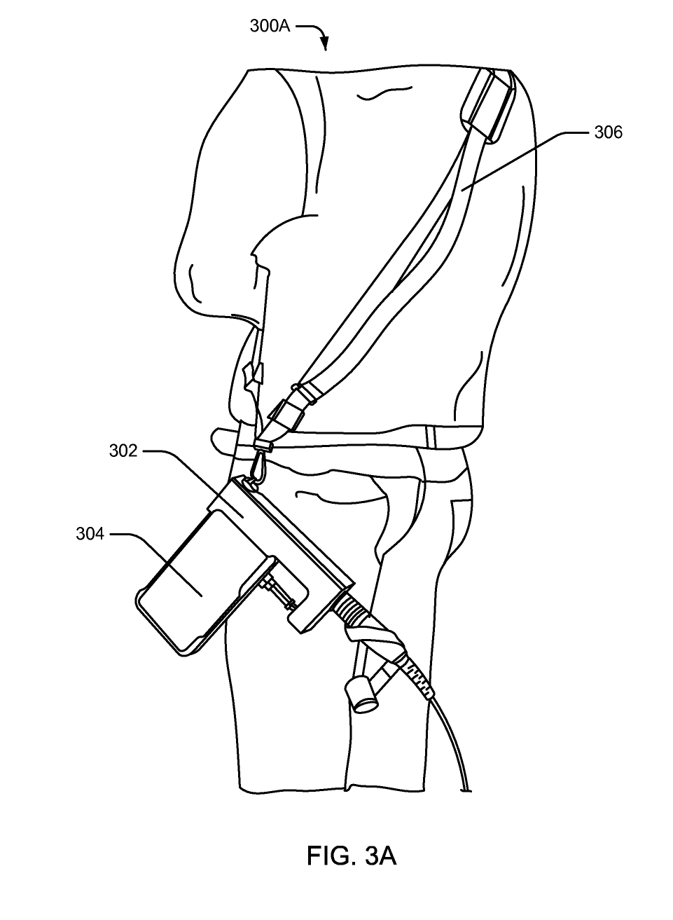

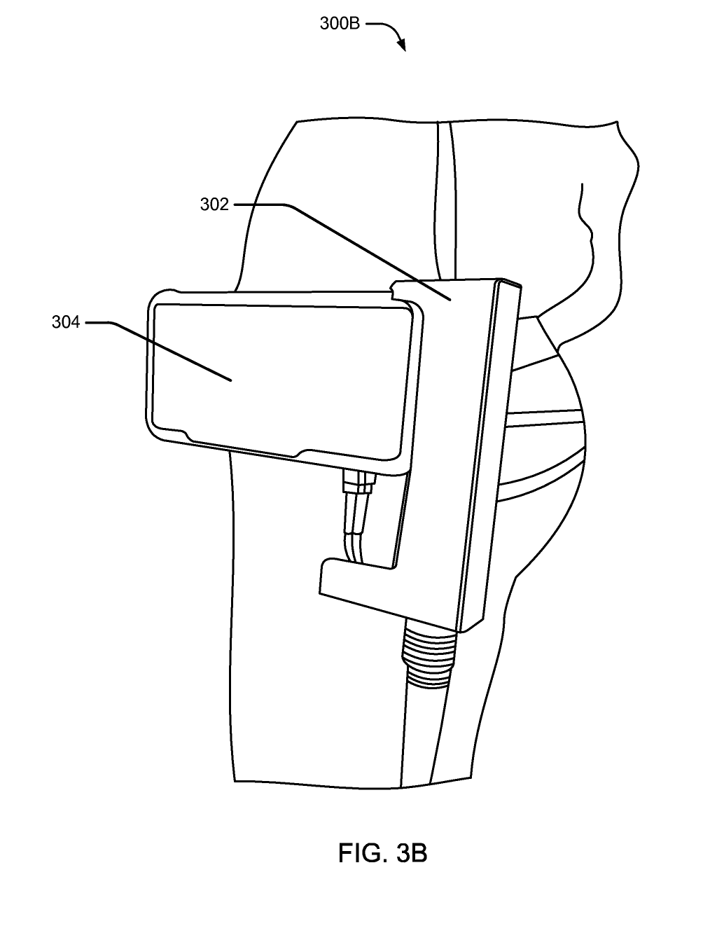

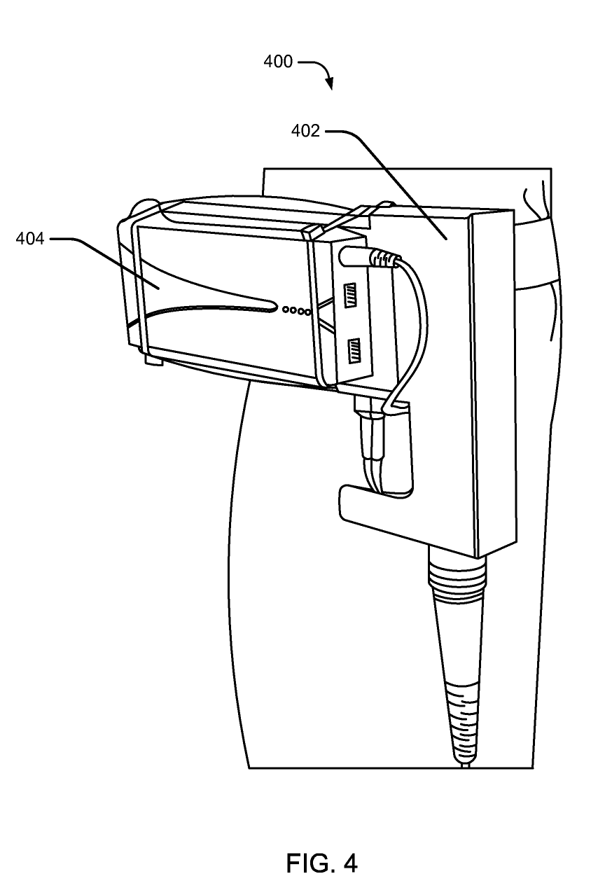

FIGS. 3A-3B illustrates snapshots 300A and 300B of the cable adapter of FIGS. 1A-1C with additional attachments, in accordance with various embodiments of the present disclosure. As shown in FIG. 3A, a cable adapter 302 may include a strap attachment 306 that may remain connected to an assembly formed by attaching an ATEM camera converter 304 to the cable adapter 302. The strap attachment 306 may allow a user to hold the cable adapter 302 along with the camera converter 304 firmly against the body of a camera operator while producing videos etc. The strap attachment 306 may be a shoulder strap as shown in FIG. 3A.

Alternatively, the assembly including the ATEM camera converter 304 and the camera adapter 302 may be fixed to a belt of an operator/user through a belt clip attachment as shown in FIG. 3B. The belt clip may be of any suitable shape.

FIG. 4 illustrates another snapshot 400 of an exemplary cable adapter/connector 402, in accordance with an embodiment of the present disclosure. As shown, the cable adapter 402 may have an additional battery 404 to provide power to cable adapter 402 or camera converter.

The present disclosure provides a camera/cable adapter kit including a bracket that can be attached to an ATEM fiber optic camera converter. The disclosed cable adapter kit may also include an optical fiber patch cable, duplex LC to duplex LC connectors, duplex LC to Dual ST or dual FC chassis connectors, Neutrik opticalCON® fiber optic patch panel connector dual ST or dual FC female patch panel connectors, at least two 3.0 mm by 20 mm screws for attaching the cable adapter to the ATEM camera converter, rivets, and wide nut/lock washers. The bracket can be an metal bracket. Further, the patch cable integral to the design of the cable adapter may connect the LC optical fiber socket on the camera converter to a choice of more durable fiber optic connectors installed on the bracket including Neutrik opticalCON® DUO or dual ST or dual FC chassis connectors. The disclosed cable adapter kit may also allow the use of alternative fiber optic cable assemblies better suited to withstand the rigors of repeated field deployment. Further, the disclosed cable adapter ensures the integrity and reliability of fiber optic cable assemblies that are used to connect the signals from or to the ATEM camera converter and the video production studio or control location.

The disclosed cable adapter enables the ATEM camera converter to be used with more durable fiber optic cables to ensure reliable fiber optic transmission without any signal interruption. Further, the bracket protects the LC connection and ensures that the LC connector(s) are securely attached. Additionally, the disclosed cable adapter may be used with various optical fiber cable assemblies including Neutrik opticalCON® and dual ST or dual FC chassis connectors.

The disclosed camera connector/adapter enables an ATEM camera converter to be used with more durable optical fiber connections and cables.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general-purpose computers, special purpose computers, or other programmable data processing translator to produce machines, such that the instructions, which execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the various embodiments of the present invention has been presented for purposes of illustration, but is not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A cable adapter for an ATEM camera converter, comprising:
a bracket secured to at least two holes on bottom of the ATEM camera converter;
a Neutrik opticalCON® fiber chassis connector secured to a cut-out in the bracket by at least two rivets;
two dual ST or dual FC chassis connectors installed in the cut-out of the bracket using one or more wide nuts with one or more lock-washers; and
one or more fiber optic cables terminating with at least one of the Neutrik opticalCON® or dual ST or dual FC chassis connectors, wherein the fiber optic cables are used with the camera converter.

2. The cable adapter of claim 1, wherein the Neutrik opticalCON® chassis connector comprises at least one of a Neutrik opticalCON® DUO connecter and a Neutrik opticalCON® QUAD connector.

3. The cable adapter of claim 1, wherein the one or more fiber optic cables are optical fiber patch cable for duplex LC to duplex LC connectors.

4. The cable adapter of claim 1, wherein the one or more fiber optic cables are optical fibers patch cable for duplex LC to dual ST or dual FC chassis connectors.

5. The cable adapter of claim 3, wherein for operation of the ATEM camera converter with fiber optic cables terminated with Neutrik opticalCON® connectors, the patch cable is connected between an inboard duplex LC socket of the Neutrik opticalCON® connector and the duplex LC socket on the ATEM camera converter.

6. The cable adapter of claim 3, wherein for operation of the ATEM camera converter with fiber optic cables terminated with the dual ST or dual FC chassis connectors, the patch cable is connected between an inboard one or more ST or dual FC sockets and the duplex LC socket on the ATEM camera converter.

7. The cable adapter of claim 1, wherein material of the bracket comprises at least one of metal or injection molded plastic.

8. The cable adapter of claim 1 further comprising a strap attachment for allowing a user to hold the cable adapter firmly on shoulder.

9. The cable adapter of claim 1 further comprising an auxiliary battery supply.

10. The cable adapter of claim 1, wherein the fiber optic cables terminating with at least one of the Neutrik opticalCON® fiber optic chassis connector and the dual ST or dual FC chassis connectors is plugged into a socket located on the ATEM camera converter.

11. The cable adapter of claim 1, wherein the bracket is configured to protect an LC connection.

12. The cable adapter of claim 1, wherein the bracket further comprises a hermaphroditic connector of other more robust fiber optic connecter with a patch cable connecting the metal to a dual LC connector on the ATEM camera converter.

13. The cable adapter of claim 1, wherein the cable adapter is configured to connect to the ATEM camera converter by using at least two 3.0 mm by 20 mm screws.

14. The cable adapter of claim 1, wherein the ATEM camera adapter is Blackmagic® ATEM camera converter.

15. A cable connector for a Blackmagic® ATEM camera converter, comprising:
a bracket secured in at least two holes on bottom of the Blackmagic® ATEM camera converter;
a Neutrik opticalCON® chassis connector secured to a cut-out in the bracket by at least two rivets;
at least two dual ST or dual FC chassis connectors installed in the cut-out of the bracket using one or more wide nuts with one or more lock-washers; and
one or more fiber optic cables which terminate with at least one of the Neutrik opticalCON® or dual ST or dual FC chassis connectors, wherein the fiber optic fibers is used with the camera converter;
a strap attachment for allowing a user to hold the cable adapter firmly; and
an auxiliary battery supply.

16. The cable adapter of claim 15, wherein the Neutrik opticalCON® chassis connector comprises at least one of a Neutrik opticalCON® DUO connecter and a Neutrik opticalCON® QUAD connector.

17. The cable adapter of claim 15, wherein the one or more fiber optic cables are optical fiber patch cable for duplex LC to Duplex LC connectors.

18. The cable adapter of claim 5, wherein the one or more fiber optic cables are optical fibers patch cable for duplex LC to Dual ST or dual FC chassis connectors.

19. The cable adapter of claim 17, wherein for operation of the Blackmagic® ATEM camera converter with fiber optic cables terminated with Neutrik opticalCON® connectors, the patch cable is connected between an inboard duplex LC socket of the Neutrik opticalCON® connector and the Duplex LC socket on the Blackmagic® ATEM camera converter.

20. The cable adapter of claim 17, wherein for operation of the Blackmagic® ATEM camera converter with fiber optic cables terminated with dual ST or dual FC chassis connectors, the patch cable is connected between an inboard one or more ST or dual FC sockets and the Duplex LC socket on the Blackmagic® ATEM camera converter.

21. The cable adapter of claim 15, wherein a material of the bracket is made of metal or plastic.

22. The cable adapter of claim 15, wherein the fiber optic cables terminating with at least one of the Neutrik opticalCON® fiber optic chassis connector and Dual ST or dual FC chassis connectors is plugged into a socket located on the Blackmagic® ATEM camera converter.

23. The cable adapter of claim 15, wherein the bracket is configured to protect an LC connection.

24. The cable adapter of claim 15, wherein the bracket further comprises a hermaphroditic connector of other more robust fiber optic connecter with a patch cable connecting the bracket to a dual LC connector on the Blackmagic® ATEM camera converter.

25. The cable adapter of claim 15, wherein the cable adapter is configured to connect to the Blackmagic® ATEM camera converter by using at least two 3.0 mm by 20 mm screws.
